(19) United States
(12) Patent Application Publication
(10) Pub. No.: US 2026/0134636 A1
(43) Pub. Date: May 14, 2026

(54) REMOTE RENDERING FOR EXTENDED REALITY (XR) SYSTEMS

(71) Applicant: QUALCOMM Incorporated, San Diego, CA (US)

(72) Inventors: Yellamraju TARUN, San Diego, CA (US); Cullum James BALDWIN, San Diego, CA (US); Vinay MELKOTE KRISHNAPRASAD, Bangalore (IN); Joseph Daniel GARVEY, San Diego, CA (US); Bojan VRCELJ, San Diego, CA (US); Wesley James HOLLAND, Encinitas, CA (US); Walker CURTIS, San Diego, CA (US)

(21) Appl. No.: 19/180,548

(22) Filed: Apr. 16, 2025

Related U.S. Application Data
(60) Provisional application No. 63/719,084, filed on Nov. 11, 2024.

(51) Int. Cl. G06T 19/00; G06F 3/01; G06F 3/14

(52) U.S. Cl. CPC G06T 19/006; G06F 3/012; G06F 3/14; G06T 2210/08

(57) ABSTRACT

Systems and techniques and provided for extended reality systems. In an example, a device may include at least one memory and at least one processor coupled to the at least one memory and configured to perform operations. The operations may include obtaining a position of an XR headset worn by a user, determining, for each three-dimensional (3D) object of a plurality of 3D objects of an XR scene, respective metadata including a respective asymmetric frustum relative to the position of the XR headset, rendering, at a respective render rate and based on the respective asymmetric frustum, each 3D object of the plurality of 3D objects in a respective two-dimensional plane to generate rendered objects, arranging the rendered objects in respective non-overlapping segments of a video frame; and transmitting the video frame and the respective metadata for each 3D object to the XR headset.

### CROSS-REFERENCE TO RELATED APPLICATIONS

The present application claims the benefit of U.S. Provisional Patent Application No. 63/719,084, filed on Nov. 11, 2024, the contents of which is incorporated herein by reference in its entirety.

### FIELD

Disclosed techniques relate to improved extended reality (XR) systems. For example, certain aspects relate to systems and techniques for improved rendering for XR systems.

### BACKGROUND

Extended reality (XR) systems or devices can provide virtual content to a user and/or can combine real-world or physical environments and virtual environments (made up of virtual content) to provide users with XR experiences. XR systems typically use powerful processors to perform feature analysis (e.g., extraction, tracking, etc.) and other complex functions quickly enough to display an output based on those functions to their users. Powerful processors generally draw power at a high rate. Similarly, sending large quantities of data to a powerful processor typically draws power at a high rate. Headsets and other portable devices typically have small batteries so as not to be uncomfortably heavy to users. Thus, some XR systems must be plugged into an external power source, and are thus not portable. Portable XR systems generally have short battery lives and/or are uncomfortably heavy due to inclusion of large batteries.

An XR system may include a head mounted display (HMD) that may be worn by a user of the XR system. Generally, it is desirable to keep an HMD display as lightweight and small as possible. To help reduce the weight and the size of an HMD display, the HMD display may be a relatively lower power system (e.g., in terms of battery and/or computational power) and the HMD display may be connected (e.g., wired or wireless connected) to another device (e.g., a mobile phone, a server device, or other device), referred to as a companion device. The companion device may be a relatively higher power system (e.g., in terms of battery and/or computational power) and may perform certain processing tasks for the HMD. For example, the companion device may perform processing tasks for generating information to be displayed on the HMD display. In some cases, such processing tasks may be split between the companion device and the HMD display. In some cases, it may be useful to reduce power consumption of the XR system.

### SUMMARY

Systems and techniques are described herein for extended reality (XR) systems. In some aspects, an apparatus for extended reality (XR) is provided. The apparatus includes at least one memory and at least one processor coupled to the at least one memory and configured to: obtain a position of an XR headset worn by a user; determine, for each three-dimensional (3D) object of a plurality of 3D objects of an XR scene, respective metadata including a respective asymmetric frustum relative to the position of the XR headset; render, at a respective render rate and based on the respective asymmetric frustum, each 3D object of the plurality of 3D objects in a respective two-dimensional plane to generate a plurality of rendered objects; arrange the plurality of rendered objects in respective non-overlapping segments of a video frame; and transmit the video frame and the respective metadata for each 3D object to the XR headset.

In some aspects, an apparatus for XR is provided. The apparatus includes at least one memory and at least one processor coupled to the at least one memory and configured to: receive a video frame and an XR object atlas including metadata; determine, from the XR object atlas, a plurality of rendered objects and a respective asymmetric frustum for each rendered object of the plurality of rendered objects; extract, from respective segments in the video frame, each of the plurality of rendered objects; project and compose each rendered object of the plurality of rendered objects into a respective two-dimensional (2D) space based on the respective asymmetric frustums; and output the projected and composed objects to a display.

In some aspects, a method for XR is provided. The method includes: obtaining a position of an XR headset worn by a user; determining, for each three-dimensional (3D) object of a plurality of 3D objects of an XR scene, respective metadata including a respective asymmetric frustum relative to the position of the XR headset; rendering, at a respective render rate and based on the respective asymmetric frustum, each 3D object of the plurality of 3D objects in a respective two-dimensional plane to generate a plurality of rendered objects; arranging the plurality of rendered objects in respective non-overlapping segments of a video frame; and transmitting the video frame and the respective metadata for each 3D object to the XR headset.

In some aspects, a method for XR is provided. The method includes: receiving a video frame and an XR object atlas including metadata; determining, from the XR object atlas, a plurality of rendered objects and a respective asymmetric frustum for each rendered object of the plurality of rendered objects; extracting, from respective segments in the video frame, each of the plurality of rendered objects; projecting and composing each rendered object of the plurality of rendered objects into a respective two-dimensional (2D) space based on the respective asymmetric frustums; and outputting the projected and composed objects to a display.

In some aspects, a non-transitory computer-readable medium is provided having stored thereon instructions that, when executed by at least one processor, cause the at least one processor to: obtain a position of an XR headset worn by a user; determine, for each three-dimensional (3D) object of a plurality of 3D objects of an XR scene, respective metadata including a respective asymmetric frustum relative to the position of the XR headset; render, at a respective render rate and based on the respective asymmetric frustum, each 3D object of the plurality of 3D objects in a respective two-dimensional plane to generate a plurality of rendered objects; arrange the plurality of rendered objects in respective non-overlapping segments of a video frame; and transmit the video frame and the respective metadata for each 3D object to the XR headset.

In some aspects, a non-transitory computer-readable medium is provided having stored thereon instructions that, when executed by at least one processor, cause the at least one processor to: receive a video frame and an XR object atlas including metadata; determine, from the XR object atlas, a plurality of rendered objects and a respective asymmetric frustum for each rendered object of the plurality of rendered objects; extract, from respective segments in the video frame, each of the plurality of rendered objects; project and compose each rendered object of the plurality of rendered objects into a respective two-dimensional (2D) space based on the respective asymmetric frustums; and output the projected and composed objects to a display.

In some aspects, an apparatus for extended reality (XR) is provided. The apparatus includes: means for obtaining a position of an XR headset worn by a user; means for determining, for each three-dimensional (3D) object of a plurality of 3D objects of an XR scene, respective metadata including a respective asymmetric frustum relative to the position of the XR headset; means for rendering, at a respective render rate and based on the respective asymmetric frustum, each 3D object of the plurality of 3D objects in a respective two-dimensional plane to generate a plurality of rendered objects; means for arranging the plurality of rendered objects in respective non-overlapping segments of a video frame; and means for transmitting the video frame and the respective metadata for each 3D object to the XR headset.

In some aspects, an apparatus for extended reality (XR) is provided. The apparatus includes: means for receiving a video frame and an XR object atlas including metadata; means for determining, from the XR object atlas, a plurality of rendered objects and a respective asymmetric frustum for each rendered object of the plurality of rendered objects; means for extracting, from respective segments in the video frame, each of the plurality of rendered objects; means for projecting and composing each rendered object of the plurality of rendered objects into a respective two-dimensional (2D) space based on the respective asymmetric frustums; and means for outputting the projected and composed objects to a display.

In some aspects, each of the apparatuses described above is, can be part of, or can include an extended reality (XR) device (e.g., a virtual reality (VR) device, an augmented reality (AR) device, or a mixed reality (MR) device), a mobile device, a smart or connected device, a camera system, or other type of device. In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIG. 3 illustrates an example of an augmented reality enhanced application engine, in accordance with aspects of the present disclosure.

FIG. 4 illustrates an example of a primary application engine and a secondary application engine that can provide an augmented reality enhancement to the primary application engine, in accordance with aspects of the present disclosure.

FIG. 5A illustrates example content used within an extended reality remote rendering framework, in accordance with aspects of the present disclosure.

FIG. 5B is a diagram illustrating an example of a system for communication between a client device and a server, in accordance with aspects of the present disclosure.

FIG. 6 illustrates an example of an extended reality system for remote rendering, in accordance with aspects of the present disclosure.

FIG. 7 illustrates an example of a host system of an extended reality system for remote rendering, in accordance with aspects of the present disclosure.

FIG. 8 illustrates an example of a viewer system of an extended reality system for remote rendering, in accordance with aspects of the present disclosure.

FIG. 9 illustrates an example of variable transmission within an extended reality system, in accordance with aspects of the present disclosure.

FIG. 10 illustrates an example of variable transmission within an extended reality system, in accordance with aspects of the present disclosure.

FIG. 11 illustrates an example of variable transmission within an extended reality system, in accordance with aspects of the present disclosure.

FIG. 12 illustrates an example of variable transmission within an extended reality system, in accordance with aspects of the present disclosure.

FIG. 13 is a flow diagram illustrating a process for remote rendering, in accordance with aspects of the present disclosure.

FIG. 14 is a flow diagram illustrating a process for remote rendering, in accordance with aspects of the present disclosure.

FIG. 15 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. Various changes may be made in the function and arrangement of elements without departing from the spirit and scope of the application as set forth in the appended claims.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. An XR system or device may take the form of an XR headset. Examples of XR headsets include head-mounted displays (HMDs), smart glasses, among others. In some cases, an XR system or device can track parts of the user (e.g., a hand and/or fingertips of a user) to allow the user to interact with items of virtual content.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As noted previously, an XR system may include an XR headset, such as AR HMD or AR glasses, that may be worn by a user. Generally, it is desirable to keep an HMD as light and small as possible. To help reduce the weight and the size of an HMD, the HMD may be a relatively lower power system (e.g., in terms of battery and computational power) as compared to a device (e.g., a companion device, such as a mobile phone, a server device, or other device) with which the HMD is connected (e.g., wired or wireless connected).

In some cases, as the HMD may be a relatively low power device, the HMD may be connected (e.g., wired or wireless connected) to another device (e.g., a mobile phone, a server device, or other device), referred to as a companion device or host device. The companion device may be a relatively higher power system (e.g., in terms of battery and/or computational power as compared to the HMD) and may perform certain processing tasks for the HMD. For example, the companion device may perform processing tasks for generating information to be displayed on the HMD display. In some cases, such processing tasks may be split between the companion device (or host device) and the HMD display.

Systems, apparatuses, electronic devices, methods (also referred to as processes), and computer-readable media (collectively referred to herein as “systems and techniques”) are described herein for providing improved rendering of content in XR systems (or devices). As noted above, XR systems can perform rendering of content (e.g., objects, images, video frames, etc.) on a host device to offload processing from the XR headset (e.g., an XR HMD, glasses, etc.), which lack the compute or battery capacity of the host device.

In traditional XR systems, objects are typically rendered by a host device according to how the objects will ultimately be displayed and are then compressed using a standard video coder-decoder (referred to as a “codec”). However, such an approach has drawbacks. For instance, standard video codecs, which are designed for two-dimensional full-frame content, are constrained by fixed size frames and fixed frame rates. Accordingly, a video codec is not able to leverage sparsity inherent in XR content (e.g., areas of a scene that lack objects, such as virtual objects) or periods of time during which no content updates are needed (e.g., in a static scene or a period of time when objects in a scene are static). Furthermore, traditional systems lack a flexibility to allocate additional resolution and/or higher render rates to certain objects that could benefit from additional detail. Examples of these objects are objects which are animating, rotating, and/or otherwise moving relative to the user. As such, these approaches can result in a lower quality XR scene and/or elevated power consumption due to more data being transmitted over a wireless link between the host device and the XR headset.

The systems and techniques described herein can address the above-noted issues. For instance, according to various aspects, the systems and techniques can employ remote rendering to improve XR quality and lower power consumption of wireless communications. By performing such remote rendering by a host device, each XR object in a scene can be rendered at an appropriate image resolution and render rate according to a pose (e.g., position and/or orientation) of a user wearing an XR headset. The host device can then position the rendered objects in non-overlapping segments of a video frame, which in turn is encoded and transmitted to the XR headset over the wireless link along with an XR object atlas of objects and their respective metadata (e.g., frustum, and so forth). For example, when content layers are grouped together into non-overlapping regions, the resulting configuration may be referred to as an atlas. The atlas can then be encoded and sent over the wireless link. The XR headset can then receive the encoded video stream and the encoded atlas. The XR headset can decode the video and the atlas and can use the atlas to identify, project, and compose the rendered and encoded objects.

Using the systems and techniques described herein, each XR object may be updated and re-rendered as appropriate, rather than being constrained by the video encoder's frame rate. Further, objects that may otherwise be obscured, for instance, by an additional object in the foreground, may be separated and more completely represented, which improves visual quality. Another advantage is that only active regions in the XR scene are rendered, and only the segments of the video frame are updated as needed. This results in the fewer pixels being rendered and power consumption being reduced due to less data being transmitted over a wireless link.

Various aspects of the application will be described with respect to the figures.

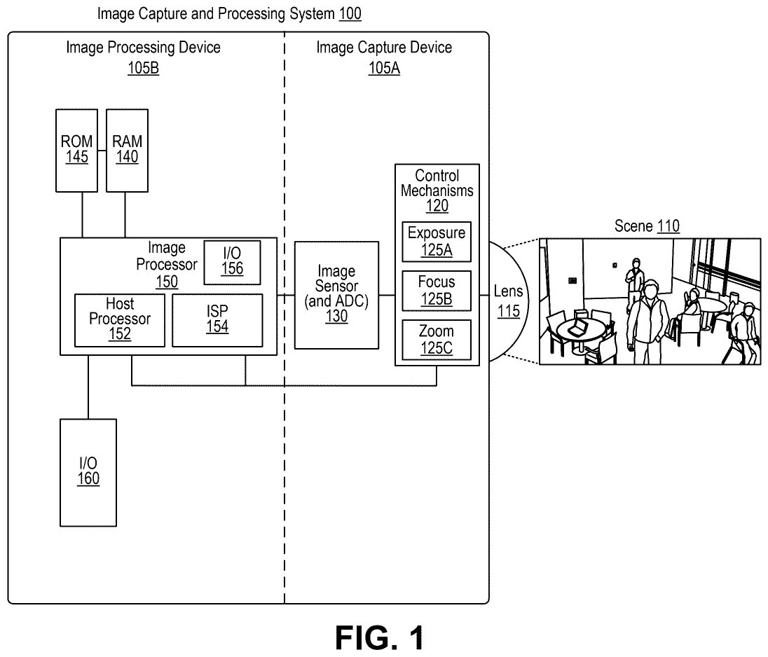

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

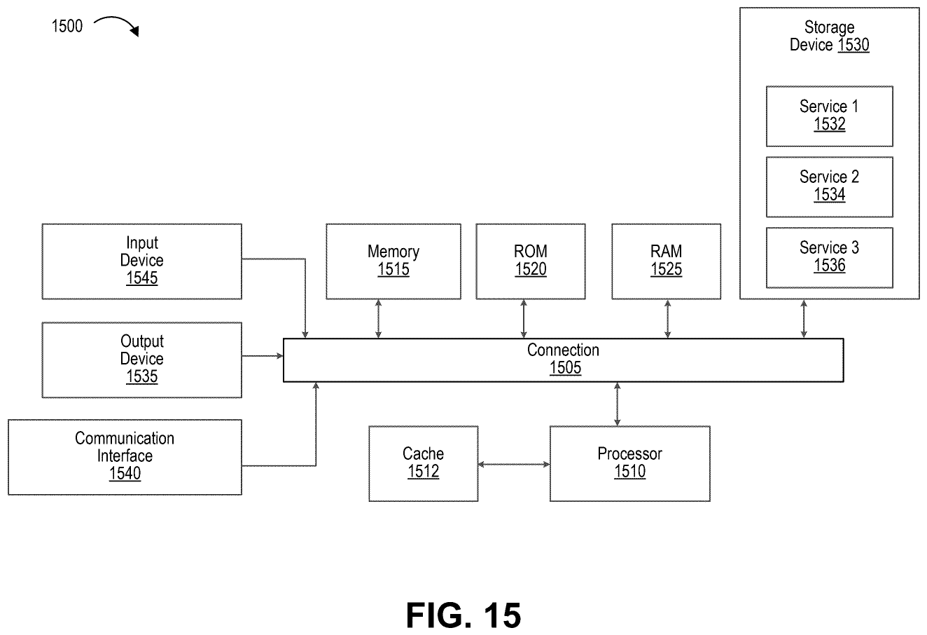

The image processor 150 may include one or more processors, such as one or more image signal processors (ISPs) (including ISP 154), one or more host processors (including host processor 152), and/or one or more of any other type of processor 1510 discussed with respect to the computing system 1500 of FIG. 15. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1435, any other input devices 1445, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

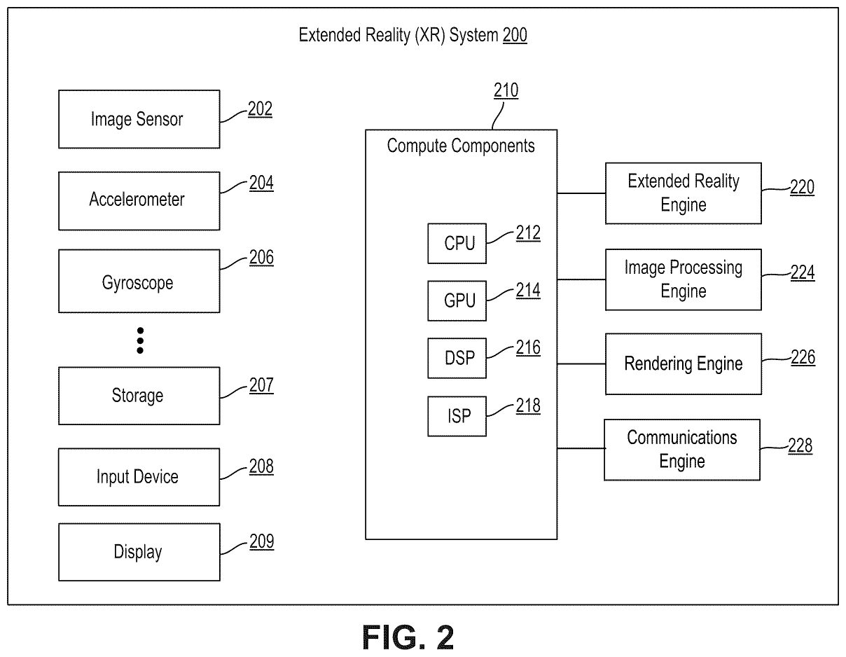

In some examples, the extended reality (XR) system 200 of FIG. 2 can include the image capture and processing system 100, the image capture device 105A, the image processing device 105B, or a combination thereof, can include the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one or more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1540 of FIG. 15.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can h SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

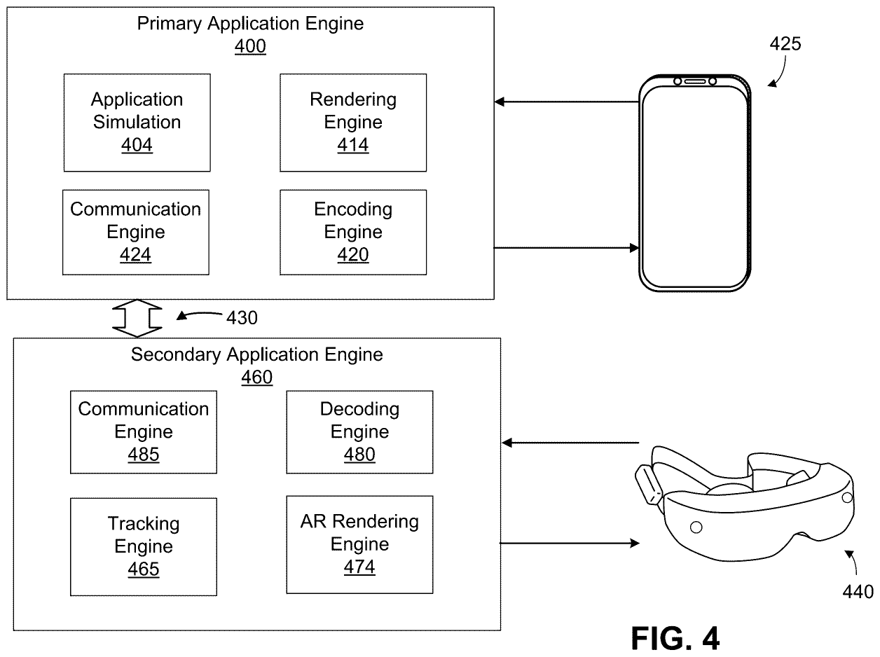

As one illustrative example, the compute components 210 can extract feature points corresponding to a mobile device (e.g., mobile device 425 of FIG. 4), or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

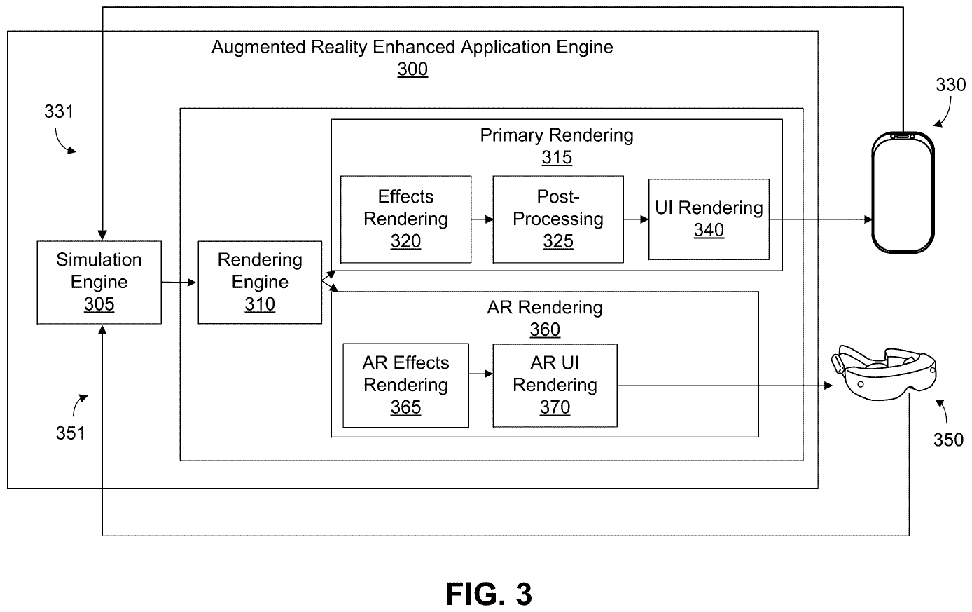

FIG. 3 illustrates an example of an augmented reality enhanced application engine 300. In the illustrative example, the augmented reality enhanced application engine 300 includes a simulation engine 305, a rendering engine 310, a primary rendering module 315, and AR rendering module 360. As illustrated, the primary rendering module 315 can include an effects rendering engine 320, a post-processing engine 325, and a user interface (UI) rendering engine 340. The AR rendering module 360 can include an AR effects rendering engine 365 and an AR UI rendering engine 370. It should be noted that the components 305-370 shown in FIG. 3 are non-limiting examples provided for illustrative and explanation purposes, and other examples can include more, fewer, or different components than those shown in FIG. 3.

In some cases, the augmented reality enhanced application engine 300 is included in and/or is in communication with (wired or wirelessly) a mobile device 330. In some examples, the augmented reality enhanced application engine 300 is included in and/or is in communication with (wired or wirelessly) an XR system 350.

In the illustrated example of FIG. 3, the simulation engine 305 can generate a simulation for the augmented reality enhanced application engine 300. In some cases, the simulation can include, for example, one or more images, one or more videos, one or more strings of characters (e.g., alphanumeric characters, numbers, text, Unicode characters, symbols, and/or icons), one or more two-dimensional (2D) shapes (e.g., circles, ellipses, squares, rectangles, triangles, other polygons, rounded polygons with one or more rounded corners, portions thereof, or combinations thereof), one or more three-dimensional (3D) shapes (e.g., spheres, cylinders, cubes, pyramids, triangular prisms, rectangular prisms, tetrahedrons, other polyhedrons, rounded polyhedrons with one or more rounded edges and/or corners, portions thereof, or combinations thereof), textures for shapes, bump-mapping for shapes, lighting effects, or combinations thereof. In some examples, the simulation can include at least a portion of an environment. The environment may be a real-world environment, a virtual environment, and/or a mixed environment that includes real-world environment elements and virtual environment elements.

In some cases, the simulation generated by the simulation engine 305 can be dynamic. For example, the simulation engine 305 can update the simulation based on different triggers, including, without limitation, physical contact, sounds, gestures, input signals, passage of time, and/or any combination thereof. As used herein, an application state of the augmented reality enhanced application engine 300 can include any information associated with the simulation engine 305, rendering engine 310, primary rendering module 315, effects rendering engine 320, post-processing engine 325, UI rendering engine 340, AR rendering module 360, AR effects rendering engine 365, AR UI rendering engine 370, inputs to the augmented reality enhanced application engine 300, outputs from the augmented reality enhanced application engine 300, and/or any combination thereof at a particular moment in time.

As illustrated, the simulation engine 305 can obtain mobile device input 331 from the mobile device 330. In some cases, the simulation engine 305 can obtain XR system input 351 from the XR system 350. The mobile device input 331 and/or XR system input 351 can include, for example, user input through a user interface of the application displayed on the display of the mobile device 330, user inputs from an input device (e.g., input device 208 of FIG. 2), one or more sensors (e.g., image sensor 202, accelerometer 204, gyroscope 206 of FIG. 2). In some cases, simulation engine 305 can update the application state for the augmented reality enhanced application engine 300 based on the mobile device input 331, XR system input 351, and/or any combination thereof.

In the illustrative example of FIG. 3, the rendering engine 310 can obtain application state information from the simulation engine 305. In some cases, the rendering engine 310 can determine portions of the application state information to be rendered by the displays available to the augmented reality enhanced application engine 300. For example, the rendering engine rendering engine 310 can determine whether a connection (wired or wireless) has been established between the XR system 350 and the mobile device 330. In some cases, the rendering engine 310 can determine the application state information to be rendered by the primary rendering module 315 and the AR rendering module 360. In some cases, the rendering engine 310 can determine that the XR system 350 is not connected (wired or wirelessly) to the mobile device 330. In some cases, the rendering engine 310 can determine the application state information for the primary rendering module 315 and forego determining application state information to be rendered by the AR rendering module 360 that will not be displayed. Accordingly, the rendering engine 310 can facilitate an adaptive rendering configuration for the augmented reality enhanced application engine 300 based on the availability and/or types of available displays. In some implementations, a separate rendering engine 310 as shown in FIG. 3 may be excluded. In one illustrative example, the primary rendering module 315 and/or AR rendering module 360 can include at least a portion of the functionality of the rendering engine 310 described above.

The primary rendering module 315 can include an effects rendering engine 320, post-processing engine 325, and UI rendering engine 340. In some cases, the primary rendering module 315 can render image frames configured for display on a display of the mobile device 330. As illustrated, the primary rendering module 315 can output the generated image frames (e.g., media content) to be displayed on a display of the mobile device 330. In some cases, the effects rendering information can render application state information generated by the simulation engine 305. For example, the effects rendering engine can generate a 2D projection of a portion of a 3D environment included in the application state information. For example, the rendering engine 320 may generate a perspective projection of the 3D environment by a virtual camera. In some cases, the application state information can include a pose of the virtual camera within the environment. In some cases, the effects rendering engine 320 can generate additional visual effects that are not included within the 3D environment. For example, the rendering engine 320 can apply texture maps to enhance the visual appearance of the effects generated by the rendering engine 320. In some cases, the rendering engine 320 can exclude portions of the application state information designated for the AR rendering module 360 by the rendering engine 310. For example, the primary rendering module 315 may exclude effects present in the environment of the simulation.

In some cases, post-processing engine post-processing engine 325 can provide additional processing to the rendered effects generated by the effects rendering engine 320. For example, the post-processing engine 325 can perform scaling, image smoothing, z-buffering, contrast enhancement, gamma, color mapping, any other image processing, and/or any combination thereof.

In some implementations, UI rendering engine 340 can render a UI. In some cases, the user interface can provide application state information in addition to the effects rendered based on the application environment (e.g., a 3D environment). In some cases, the UI can be generated as an overlay over a portion of the image frame output by the post-processing engine 325.

The AR rendering module 360 can include an AR effects rendering engine 365 and an AR UI rendering engine 370. In some cases, the AR effects rendering engine 365 can render application state information generated by the simulation engine 305. For example, the AR effects rendering engine 365 can generate a 2D projection of a 3D environment included in the application state information. In some cases, the AR effects rendering engine 365 can generate effects that appear to protrude out from the display surface of the display of the mobile device 330.

In some cases, the display of the XR system 350 can have different display parameters (e.g., a different resolution, frame rate, aspect ratio, and/or any other display parameters) than the display of the mobile device 330. In some cases, the display parameters can also vary between different types of output devices (e.g., different HMD models, other XR systems, or the like). As a result, rendering display data for the XR system 350 with the AR rendering module 360 can affect performance of the primary rendering module 315 (e.g., by consuming computational resources of a GPU, CPU, memory, or the like). In some cases, inclusion of the AR rendering module 360 within the augmented reality enhanced application engine 300 can require periodic updates to provide compatibility with different devices.

FIG. 4 illustrates an example of a primary application engine 400 and a secondary application engine 460 that can provide an augmented reality enhancement to the primary application engine 400. In the illustrative example of FIG. 4, the primary application engine 400 includes a simulation engine 404, a rendering engine 414, an encoding engine 420, and a communication engine 424. In the illustrated example, the secondary application engine 460 includes a tracking engine 465 (e.g., XR engine 220 of FIG. 2), an AR rendering engine 474, a decoding engine 480, and a communication engine 485. As illustrated, the primary application engine 400 and secondary application engine 460 can communicate over a (wired or wireless) communications link 430. It should be noted that the components 404-424 shown in the primary application engine 400 of FIG. 4 are non-limiting examples provided for illustrative and explanation purposes, and other examples can include more, fewer, or different components than those shown in FIG. 4. Similarly, it should be noted that the components 465-485 shown in the secondary application engine 460 of FIG. 4 are non-limiting examples provided for illustrative and explanation purposes, and other examples can include more, fewer, or different components than those shown in FIG. 4.

In the illustrated example of FIG. 4, the simulation engine 404 of primary application engine 400 can generate a simulation for an application on a mobile device 425. In some cases, the simulation can include, for example, one or more images, one or more videos, one or more strings of characters (e.g., alphanumeric characters, numbers, text, Unicode characters, symbols, and/or icons), one or more two-dimensional (2D) shapes (e.g., circles, ellipses, squares, rectangles, triangles, other polygons, rounded polygons with one or more rounded corners, portions thereof, or combinations thereof), one or more three-dimensional (3D) shapes (e.g., spheres, cylinders, cubes, pyramids, triangular prisms, rectangular prisms, tetrahedrons, other polyhedrons, rounded polyhedrons with one or more rounded edges and/or corners, portions thereof, or combinations thereof), textures for shapes, bump-mapping for shapes, lighting effects, or combinations thereof. In some examples, the simulation can include at least a portion of an environment. The environment may be a real-world environment, a virtual environment, and/or a mixed environment that includes real-world environment elements and virtual environment elements.

In some cases, the simulation generated by the simulation engine 404 can be dynamic. For example, the simulation engine 404 can update the simulation based on different triggers, including, without limitation, physical contact, sounds, gestures, input signals, passage of time, and/or any combination thereof. As used herein, an application state of the primary application engine 400 can include any information associated with the simulation engine 404, effects rendering engine 414, communication engine 424, and/or any combination thereof at a particular moment in time.

The communication engine 424 of the primary application engine 400 and the communication engine 485 of the secondary application engine 460 can communicate over a communications link 430. In some cases, the communications link 430 can be bidirectional. In some examples, the communication engine 424 can transmit application state information (e.g., from the simulation engine 404) to the communication engine 485 of the secondary application engine 460. In some cases, the application state information can include information that can be used to generate AR effects. In some examples, the application state information can include data that can be used by the secondary application engine 460 to generate an AR UI. In some cases, the communication engine 424 can also transmit inputs obtained from the mobile device 425 over the communications link 430 to the communication engine 485. In some cases, the communication engine 485 of the secondary application engine 460 can transmit pose information, connectivity status, user inputs, or the like to the communication engine 424 of the primary application engine 400. The communication engine 424 and communication engine 485 can also transmit and/or receive synchronization signals for synchronizing display between a display of the mobile device 425 and a display of an HMD 440. The examples of communications between the communication engine 424 and communication engine 485 provided herein are non-limiting and provided as examples. In some cases, more, fewer, and/or different information can be communicated over the communications link 430 without departing from the scope of the present disclosure. While an HMD 440 is used as an illustrative example of an XR device herein, the systems and techniques can be used for any type of XR device, such as AR, VR, or MR glasses.

Referring to the secondary application engine 460, the tracking engine 465 can perform tracking (e.g., SLAM, VIO, etc.) using information captured by sensors (e.g., image sensor 202, accelerometer 204, gyroscope 206 of FIG. 2, or the like). In some cases, tracking engine 465 can determine a pose of the mobile device 425, a pose of the HMD 440, an environment map, or the like. In some aspects, the tracking engine 465 can determine a contour of a display of the mobile device 425. In some cases, the contour of the display of the mobile device 425 can include a boundary. In some cases, the pose of the mobile device 425 and/or the contour, and/or boundary of the display of the mobile device 425 can be output to the AR rendering engine 474 to provide a target for displaying the AR information (e.g., AR effects, AR UI) on a display of the HMD 440.

The AR rendering engine 474 can be similar to and perform similar functions to the AR rendering module 360 of FIG. 3. For example, in some implementations, the HMD 440 can include an AR effects rendering engine (e.g., AR effects rendering engine 365 of FIG. 3) and/or an AR UI rendering engine (e.g., AR UI rendering engine 370 of FIG. 3). In some cases, the AR rendering engine 365 can output AR media content to the HMD 440 with different display parameters (e.g., a different resolution, frame rate, aspect ratio, and/or any other display parameters) than the media content output from the rendering engine 414 to the mobile device 425. In some cases, by dividing the rendering functionality between a primary application engine 400 and a secondary application engine 460, the computational resources for providing an AR enhanced application experience can be shared between computational resources of multiple devices such as the mobile device 425 and HMD 440. In addition, providing a separate AR rendering engine 474 in the secondary application engine 460 can simplify development of the primary application engine 400. For example, the rendering engine 414 of the primary application engine 400 may not require maintaining compatibility with a variety of different mobile devices with different display configurations.

In some cases, the HMD 440 may be relatively constrained in terms of battery and processing power, as compared to mobile device 425, to allow the HMD 440 to be wearable. To reduce processing requirements for the HMD 440, frames for display by the HMD 440 may be rendered by the mobile device 425 and transmitted to the HMD 440 via communications link 430. In some cases, the HMD may receive multiple frames for display to the user concurrently. For example, the rendering engine 414 of the mobile device 425 may render a left eye frame, a right eye frame, and, in some cases, provide depth information. For instance, the depth information can include information indicating distances of points in a scene (e.g., points corresponding to a surface of an object) from a point of view, such as a camera viewpoint. In some cases, the depth information may be inferred based on differences between the left eye frame and the right eye frame received, for example, by the HMD 440. In some cases, the depth information may be used to warp (e.g., apply a displacement vector to) portions of the frames to help adjust for movement of objects that may move independently of the camera (such as cameras on the HMD 440), between the time when the frames are rendered by the rendering engine 414 and the time when the frames are received by the HMD 440. The rendered frame may be in any known frame or video format. In some cases, the frames may only include objects to be overlaid on an environment visible through the HMD 440. An encoding engine 420 may encode the rendered frames to reduce a size of the frames for transmission. The encoded frames may be transmitted, via communication engine 424 and communications link 430, to the HMD 440.

The HMD may receive the encoded frames via communication engine 485. For example, these received frames may then be decoded by decoding engine 480. In some cases, there may be a delay (e.g., display latency) introduced by the rendering, encoding, transmitting, receiving, and decoding process, and during this display latency, a user may, for example, move the HMD 440. This movement may not be accounted for by the frames as rendered by the rendering engine 414 and any objects in the rendered frames may be displayed in a different location than expected due to the movement. To account for the potential motion of the HMD 440, the AR rendering engine 474 may warp the received frames based on pose and/or tracking information from the tracking engine 465 describing the movement of the HMD 440.

As an example, an XR system, such as the one shown in FIG. 4, using split or remote rendering may include a host device (e.g., mobile device 425) and an HMD (e.g., HMD 440). In some cases, content associated a hand of a user of the XR system (e.g., a representation of a hand, content being manipulated by the hand, virtual controls, certain UI elements, etc.) may be displayed along with other content. To render content associated with the hand, the XR system may use pose information for the HMD (e.g., 6DoF pose information, HMD pose (e.g., head pose) information) as well as pose information for the hand(s) of the user. The content associated with the hand may be rendered based on the hand pose information while the other content may be rendered based on the HMD pose. In some cases, the HMD may generate HMD pose information using any technique as described above. The HMD pose may be relatively quicker to generate as compared to generating the hand pose.

The HMD may also estimate hand pose, for example, by capturing images of the environment including the hand(s) of the user and inputting the captured images to one or more machine learning (ML) algorithms trained to estimate the hand pose using the captured images. In some cases, the hand pose may be relative to the HMD pose. The HMD pose and hand pose (e.g., pose information) may be transmitted by the HMD to the host device via a communications link (e.g., communications link 430). In some cases, images of the environment along with additional data for rendering a frame (e.g., audio data, additional sensor information, etc.) may also be transmitted to the host device along with the pose information. The host device may render the content for display in a frame based on the received hand pose information and other information for rendering the frame (e.g., HMD pose, images, audio data, etc.). This rendered content may be encoded and packetized for transmission to the HMD by the host device. After transmitting the pose information, the HMD may determine one or more updates for the HMD pose and the hand pose. The HMD may receive the encoded rendered content and decode the encoded rendered content. The decoded rendered content may then be warped (e.g., reprojected) based on the updated HMD pose and updated hand pose. The warped rendered content may be displayed by a display of the HMD to the user.

An XR system may render content for display regularly at a certain framerate. As discussed above content for display may be rendered based on the HMD pose and hand pose. To provide a good user experience, the HMD pose and hand pose may be determined for a frame to be rendered. In some cases, the process for determining the hand pose may be latency sensitive. For example, where a hand pose is not determined for a frame being rendered, the frame may be rendered using an older (e.g., older in time) hand pose that may not properly represent a current location and position of the hand. Rendering based on an older hand pose may result in a perceptible tearing and/or lag for content being displayed based on the hand pose. As another example, if a hand pose is received by a host device too early, there may be some limited prediction error as the post-rendering warping performed by the HMD may not be able to sufficiently adjust the warping to account for the increased time between when the hand pose was provided to the host device and when the rendered image is provided to the HMD.

The hand pose may be determined using a hand tracking (HaT) algorithm. In some cases, an amount of time used by the HaT algorithm to determine the hand pose may be variable. For example, the amount of time used by the HaT algorithm may depend on, for example, a number of hands present in a field of view (FOV) of the XR system (e.g., visible in the FOV through the HMD), a complexity of a captured image (e.g., image with lots of textures, surfaces, etc.), and the like. As an example, under ideal conditions, the HaT algorithm may determine a hand pose just in time before rendering is performed. In some cases, the hand pose may be determined in time to be transmitted together with other information for rendering a frame (e.g., HMD pose, image, etc.) to the host device, allowing for network batching. Using network batching to transmit data for rending an image to the host device may allow for reduced power consumption by the communications hardware (e.g., Wi-Fi chipset) as the network communications hardware may wakeup to perform the batched transmission and then enter a low power state.

As an example, under adverse conditions, the HaT algorithm may determine the hand pose late, such as after rendering has started. In such a case, a frame may be rendered using an older hand pose (e.g., a hand pose used to render a previous frame). In some cases, rendering using an older hand pose may cause content associated with a hand to be rendered in a pose which does not match a current pose of the hand. This may result in the content “skipping” when the hand pose information later catches up to the rendered frames or a perceptible lag between where a user's hand is (e.g., at the current hand pose) and the rendered content associated with the hand. As another example, if the HaT algorithm determines and provides the hand pose to the host device early, the host device may render a frame using the early hand pose and pass the frame rendered based on the early hand pose back to the HMD for reprojection. However, the HMD may reproject the frame based on an estimated time for the hand pose, which may result in prediction error.

Additionally, when the hand pose is determined at a different time as compared to the other information for rendering a frame, network batching may not be used (e.g., the hand pose information may be sent to the host device in a different transmission from other information for rendering the frame), which may result in increased energy consumption as the communications hardware may exit the low power state to transmit the hand pose information. In some cases, techniques to determine the hand pose at a fixed time may be useful.

As noted previously, systems and techniques are described herein are related to improved rendering of content in XR systems. As discussed, traditional approaches to rendering may result in a sparsity of the XR content not being exploited, which in turn increases power consumption caused by the transmitted and received content.

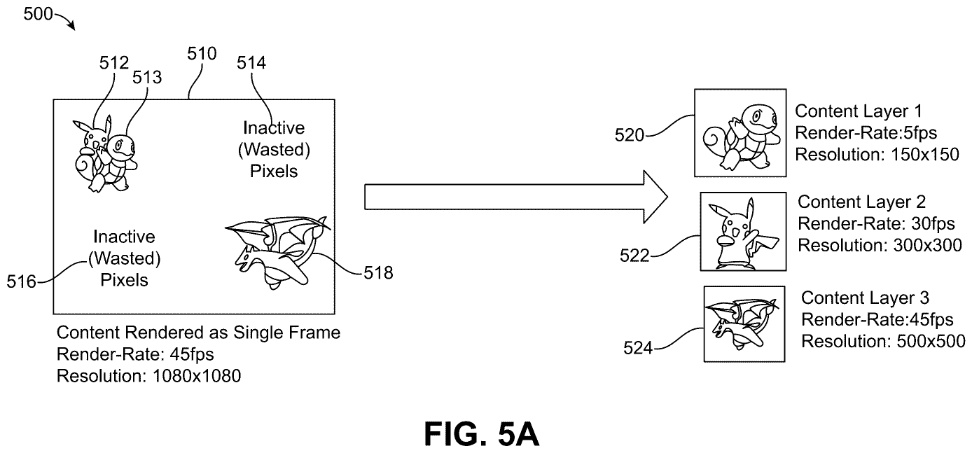

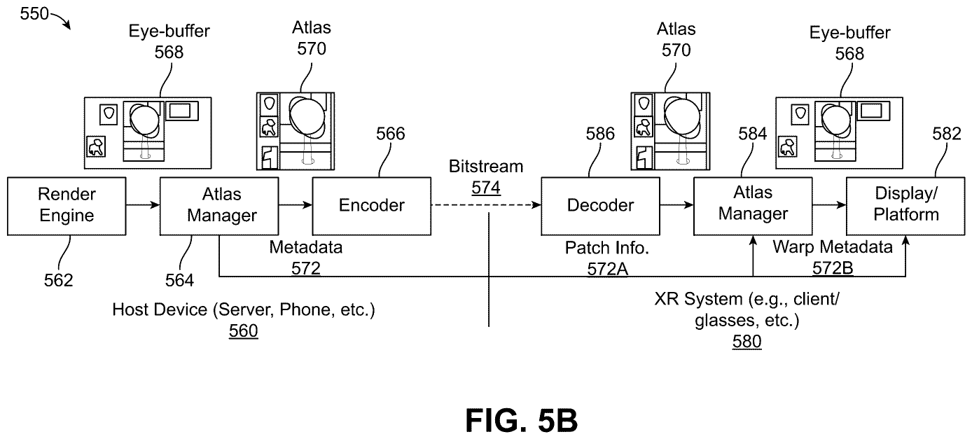

FIG. 5A illustrates concepts relating to remote rendering. In particular, FIG. 5A illustrates example content 500 used within an extended reality remote rendering framework, in accordance with aspects of the present disclosure. Content 500 includes frame 510 and content layers 520, 522, and 524.

Frame 510 represents results of a traditional approach to rendering and compression, which can be employed with virtual reality (VR) or augmented reality (AR) content. Frame 510 includes object 512, object 513, object 518, inactive area 514, and inactive area 516. Objects 512 and 518 may be in their respective original locations within the frame, which results in the inactive areas 514 and 516. Further, the positioning of object 513 obscures object 512.

In an example, frame 510 may be rendered as single frame at 45 frames per second (fps) and then compressed for transmission using a video codec such as High Efficiency Video Coding (HEVC) or Motion Picture Experts Group (MPEG). However, as explained below, this results in higher power consumption and in this case, given that object 512 is partially covered by object 513, such an approach could result in only partial rendering and encoding of object 512, resulting in lower quality.

By contrast, separating objects using content layers can result in lower power consumption and increased quality. For example, each of content layers 520, 522, and 524 include objects to be rendered. For example, as depicted, object 513 is separated into content layer 520, object 512 into content layer 522, and object 518 is separated into content layer 524. A content layer may include one or more objects, images, or video frames. For instance, a content layer may include an XR object such as an animated character. In another example, a content layer may include a video stream in a rectangular (e.g., 16:9 or 4:3) area.

Using content layers 520, 522, and 524 represents an improved approach to rendering and compression of XR content. Each content layer may have different render rates and/or resolutions. A render rate refers to a rate at which the headset will render the content. For instance, content layer 520 has a render rate of 5 fps and a resolution of 150×150 pixels, content layer 522 may have a render rate of 30 fps and a resolution of 300×300 pixels, and content layer 524 has a render rate of 45 fps and a resolution of 500×500 pixels. Other examples are possible.

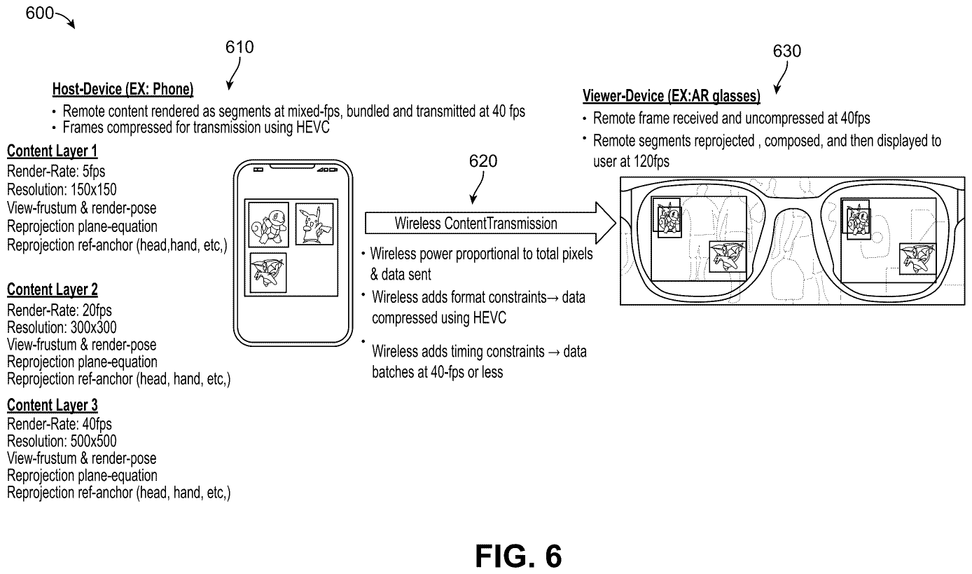

As explained further herein, objects may be separated placed at different locations within a video frame prior to encoding of the video frame using video compression. Accordingly, each content layer 520, 522, and 524 may have corresponding metadata that is determined by the host device. The metadata may include a representation of depth information of content. For example, the metadata may include a position (e.g., a pose, which can include a translational position and/or orientation), a corresponding view frustum, a render-pose, a reprojection plane-equation, and/or a reprojection reference anchor (head, hand, etc.). A view frustum represents a visible volume of a scene as observed from a future predicted position of the user/user device (e.g., XR devices or system, such as XR system 350). This metadata facilitates correct placement of the object by the headset device following transmission over the wireless network. The metadata may be transmitted with its respective content or object, and/or in a data store such as an atlas. The atlas may include a list of the layers, a type of layer (e.g., object, video, etc.), and any information needed to properly display the layer on the headset device. FIG. 6 depicts an example of a system that uses such techniques.

FIG. 5B is a diagram of a system 550 for communication between an XR system 580 (e.g., a client device, such as an HMD, AR glasses, or other XR system) and a host device 560 (e.g., a server, a mobile device, or other host device) in accordance with aspects of the present disclosure. In some cases, the combined system 550 including the host device 560 and XR system (client) 580 can coordinate a split rendering of XR content (e.g., AR content or other type of XR content). AR content will be used herein as an illustrative example of XR content. The host device 560 and the XR system 580 can be configured to generate and/or process an eye-buffer 568 and an atlas 570. For example, the host device 560 can perform a number of different functions, such as rendering, atlas management, encoding, among other functions. The system 580 can also perform different functions, such as decoding, atlas management, XR runtime, display, among others. Moreover, it is generally noted that each of the host device 560 and/or XR system 580 can include one or more of image capture and processing system 100, XR system 200, augmented reality enhanced application engine 300, primary application engine 400, secondary application engine 460, and/or computing system 1500 to perform the functional and techniques described herein.

According to some aspects, the host device 560 includes a render engine 562 that is configured to produce a sparse eye-buffer 568 that includes the active parts or components of the AR content (e.g., the eye-buffer 568 does not include pixels in the frame that correspond to the transparent background of the rendered content). In one aspect, the eye-buffer 568 is generated by selecting (e.g., touching via a user interface, by using one or more gestures to indicate, etc.) the rendered pixels to select the active portions of the AR content. In another aspect, the produced eye-buffer 568 includes those portions of the rendered AR content that is visible by the user apart from the field of view that is transparent through which the real world is viewed. The host device 560 further includes an atlas manager 564 that is configured to collate together the eye-buffer 568 to generate a compact atlas 570. For example, the generated compact atlas contains only those portions of AR content required by the XR system 580 for recreating and displaying the AR content. The remaining portions of pixels of each frame of the AR content that are not needed by the XR system 580 will be excluded from the compact atlas 570 according to an aspect.

As further shown, the host device 560 includes an encoder 566 that is configured to encode media content before transmitting the encoded content to the XR system 580. In various aspects, the encoder 566 can be an H.264 encoder, an H.265 (HEVC) encoder, an H.266 (VVC) encoder, an MPEG encoder, an AOMedia Video 1 (AV1) encoder, or other type of encoder (or combined encoder-decoder, referred to as a codec). For example, the encoder 566 can receive the compact atlas 570 that is generated by the atlas manager 564 and can encode the compact atlas 570. The encoder 566 can also encoder the media content. The host device 560 can stream (e.g., as bitstream 574) the encoded content to the XR system 580. In an aspect, the bitstream 574 can be transmitted to the XR system 580 using communication interface 1540 as described above with respect to FIG. 15.

Moreover, the atlas manager 564 is further configured to generate metadata 572 that informs the client 580 of the mapping of locations between the rendered eye-buffer 568 and the atlas 570 having the same content, which can include patch information, for example, of the sparse AR content. For example, the metadata 572 can include patch information 572A that can be processed by the XR system 580 to determine the respective positions of each active portion of the eye-buffer 568 used to generate atlas 570. Additional metadata can include warping metadata 572B, such as a head pose, depth of each active part, or three dimensional locations of the active portion, may also be sent as part of the stream. In general, the metadata 572 can be transmitted with the bitstream 574 of the encoded atlas 570 or as a separate stream to client 580.

The client 580 can then receive the encoded content (e.g., bitstream 574) and the metadata 572. In an aspect, the bitstream 574 can be received using communications engine 228 of FIG. 2, the communications engine 485 of FIG. 4, the communication interface 1540 of FIG. 15, or other communication interface or engine.

The client 580 may include similar components as the host device 560, but can be configured to perform the opposite job of the host device 560 (e.g., demultiplexing the decoded atlas 570 into an eye-buffer 568 based on the received metadata). For instance, the client 580 includes decoder 586 (e.g., an H.264 decoder, an H.265 (HEVC) decoder, an H.266 (VVC) decoder, an MPEG decoder, an AV1 decoder, or other type of decoder or codec) that is configured to decode the received bitstream 574.

The atlas manager 584 is configured to receive and process the atlas 570 to separately obtain the eye buffer 568. For example, the atlas manager 584 can be configured to use the patch information 572A to determine the respective locations of each portion of the content within atlas 570 and, in turn, reproduce eye-buffer 568. The eye-buffer 568 can then be output to display/platform 582 (e.g., XR runtime on an AR display device, such as glasses or the like), which also uses the warp metadata 572B to produce/display the AR content, the details of which will be discussed below.

FIG. 6 illustrates an example of an extended reality system 600 for remote rendering, in accordance with aspects of the present disclosure. System 600 includes a host device 610, a wireless transmission link 620, and a headset device 630. An example of host device 610 is the mobile device 330. An example of the viewer device 630 is XR system 350.

In the example depicted by system 600, each object or layer is rendered at an appropriate image resolution and render rate and according to a position and/or pose of the user. The rendered objects and layers are then separated and positioned in unused, non-overlapping segments of a video frame. The segments can be defined by a mask, or a bounding box. Use of pixel bounding boxes allows for skipping of inactive pixels, which may significantly reduce warp and composition cost on glasses.

The video frame (and in some cases additional video frames) is/are then rendered and provided to a video encoder that can encode the frame into an encoded bitstream. An atlas of objects and their respective metadata (e.g., frustum, and so forth) is also encoded and transmitted. For instance, as noted previously, when content layers are grouped together into non-overlapping regions, the resulting configuration is referred to as an atlas. The atlas can then be encoded into the encoded bitstream. The objects may be individually updated, or refreshed, at a particular frame rate, and may be a different resolution. The encoded video stream (including the encoded frames and atlas) is transmitted over the transmission link 620 and is output at the headset device 630. In turn, the headset receives the encoded bitstream including the encoded video and the encoded atlas and can decode the video and the atlas. The headset can then use the atlas to identify, project and compose the rendered and encoded objects. On the headset device 630, each frame is constructed by independently reprojecting the visible parts of each layer and then compositing the layers together into a final image.

In some cases, layers may be more accurately modeled by planes, and planar-reprojection tends to preserve clean lines and edges. By contrast, non-planar content is not always well-modeled by a plane and may require a higher render rate to update the view when the user pose changes. Using segments allows for providing occlusion/disocclusion information between layers, avoiding reprojection hole artifacts. This approach saves power by reducing wireless data as a depth-map can be skipped and sparse segments can be modeled by planes which are represented numerically. Further, remote render can update segments are different rates reducing total pixels rendered by phone.

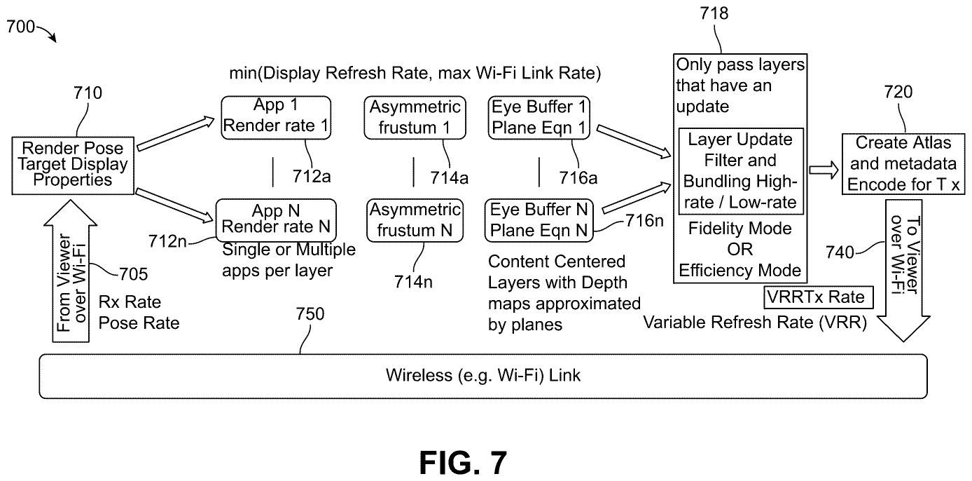

FIG. 7 illustrates an example of a host system 700 of an extended reality system for remote rendering, in accordance with aspects of the present disclosure. System 700 includes blocks 710, 712 a-n, 714 a-n, 716 a-n, 718, 720, 705, 740, and wireless link 750. System 700 is typically implemented by a host device such as device 330 in FIG. 3.

At block 705, information is received from the headset (viewer) over wireless link 750. In some cases, a pose rate is received from the headset (viewer) to the host. In some cases, the headset sends a current position of the user (e.g., a pose of the head of the user, such as a translational position and/or orientation of the head) to the host device. In some cases, a receive rate may be adjusted to match a pose rate.

At block 710, the system 700 sends information to one or more applications 712a-n. The information can include the current position of the head of the user. In some configurations, one application 712a-n can render a single object. It is possible therefore that there are multiple applications 712a-n, one for each object. In other cases, a single application 712a-n can render multiple objects.

Continuing the example, the applications 712a-n may calculate an estimated position of the head at a future time, for instance, 10 milliseconds (ms) in the future. Rendering therefore may be based on the future position. Each object is rendered in a two-dimensional space based on the corresponding frustum. Therefore, each application 712a-n may calculate a respective view frustum based on a future position of the user. A view frustum represents a visible volume of a scene as observed from a future position of the user.

Each application 712a-n outputs a respective rendered object, asymmetric frustum 714a-n, and in some cases, a respective eye buffer and plane equation 716a-n. The rendered objects, frustum, eye buffers, and plane equations, as appropriate are combined at block 718 into a video frame. The additional information helps describe orientation and help with orientation when the object is ultimately displayed. When content is rendered based on the view frustum configuration, the output (block 716a-n) is a frame buffer (the image content), and the depth information is approximated by a plane equation.

At block 720, an atlas and metadata are created, and the frame is encoded for transmission. Any suitable video codec may be used. Non-limiting examples include MPEG-2, MPEG-4, HEVC, and so forth. Metadata indicator to designate if certain layer update was received. At block 740, the encoded video stream is provided over wireless link 750.

As discussed further, rendering can repeat at a corresponding render rate, which may be different than an output video refresh rate. A given layer can use a different refresh rate. In some cases, each layer can have an update sent at arbitrary times instead of fixed rates. In some cases, only rendered objects that have changed are provided to the video encoder.

In an aspect, different quality modes are possible. For instance, a fidelity mode or an efficiency mode may be selected. Fidelity mode may involve transmitting an entire frame as often as possible, e.g., whenever an object is updated, even if other objects have not updated. Fidelity mode may consume more power but results in higher quality. By contrast, efficiency mode uses less power. In this mode, as updates arrive, the system waits for a short time to bundle updates that may be slightly offset in time. In this manner, one updated atlas is created rather than multiple. The system will keep reprojecting the previous content until the update arrives. In this case, visual quality may suffer. The active mode may be dynamically adjusted.

The atlas may be transmitted on an independent schedule or when an object is updated. For example, the atlas may be transmitted at a variable refresh rate. In an aspect, updates to the atlas may be sent more or less frequently based on whether new or updated objects are present. A maximum transmission rate may be the minimum of a wireless limit and a refresh rate of the headset display.

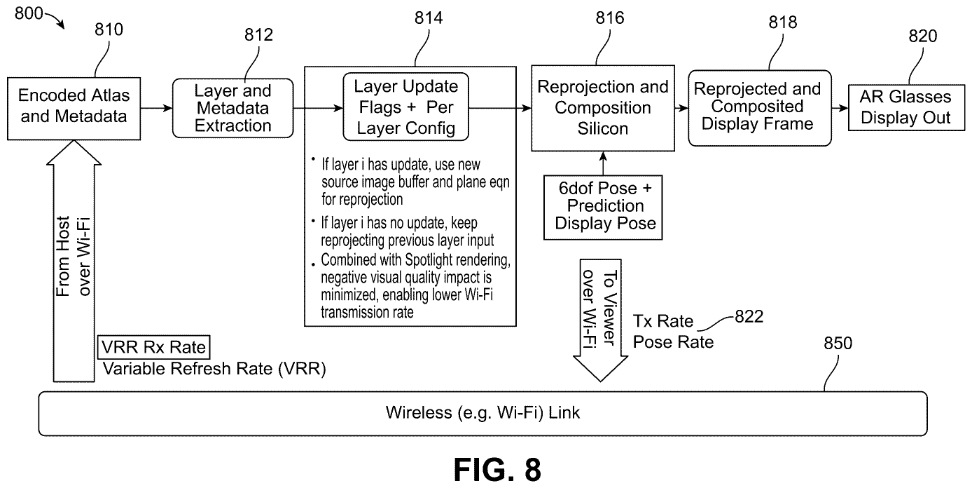

FIG. 8 illustrates an example of a viewer system 800 of an extended reality system for remote rendering, in accordance with aspects of the present disclosure. System 800 includes blocks 810, 812, 814, 816, 818, 820, 822, and wireless link 850. System 800 is typically implemented by a viewer (headset) device such as XR system 350 in FIG. 3.

At block 810, the encoded atlas and metadata are received over the wireless link 850. At block 812, the layer information and metadata are extracted from the atlas.

At block 814, a determination is made, for each layer, as to whether the layer has been updated. In some cases, objects may be classified on a spectrum. For example, some objects may be transmitted once and never changed if sufficiently high quality, whereas other objects may be constantly updated, for example if the object is moving constantly. If the object has been updated, then a new source image is extracted from the video frame. By contrast, if there is no update, then the previous object is used.

At block 816, each object is reprojected and composed based on their respective metadata into a new 2-D image. The reprojection and composition may be performed based on an updated pose and a predicted display pose for the user. At block 822, the updated pose and predicted display pose is transmitted over the wireless link 850 to the host device. The reprojected and composited display frame is assembled. At block 820, the display frame is provided to the display, e.g., the glasses. Block 816 outputs the final display frame 818 which is then sent out to the display 820.

In an aspect, a render rate and a transmission rate of an object may change based on a type of the layer, specifically, whether the layer is planar or not planar, and whether the layer is static or dynamic. The table below illustrates some examples.

| Layer Type | Trigger for render and transmission |
|---|---|
| Planar - Static | Large pose-delta/head-movement |
| | (e.g. 1 fps) |
| Planar - Dynamic | Dynamic refresh rate, large pose-delta/head-movement |
| | (e.g. 45 fps) |
| Non-planar | Pose delta resulting in disocclusion of 3D geometry |
| Static | (e.g. 10 fps) |
| Non-planar | Animation refresh rate, disocclusion pose delta |
| Dynamic | (e.g. 30 fps) |

An object that is planar and static, for example, a box, may be easy to render, and therefore, can be updated at a slow render rate, e.g., 1 fps. By comparison, a movie screen, which is also rectangular, but dynamic, may be rendered at a higher render rate, e.g., 45 fps. A non-planar static object, for example, a donut, is not well modeled plane because reprojection may result in distortion, therefore, may be rendered at a rate higher than the planar static case, but lower than the planar dynamic case, e.g., 10 fps. Finally, a non-planar dynamic object, for example, an animated character, may be moving and require frequent reprojection to look correct, may require a higher refresh rate, e.g., 30 fps.

In some cases, a layer update filter may be used. A layer update filter includes conditions under which an update would be rendered and transmitted over the wireless link. In some cases, the above frame rates may be adjusted upwards or downwards based on how often the user is moving their head, to reflect a changing pose.

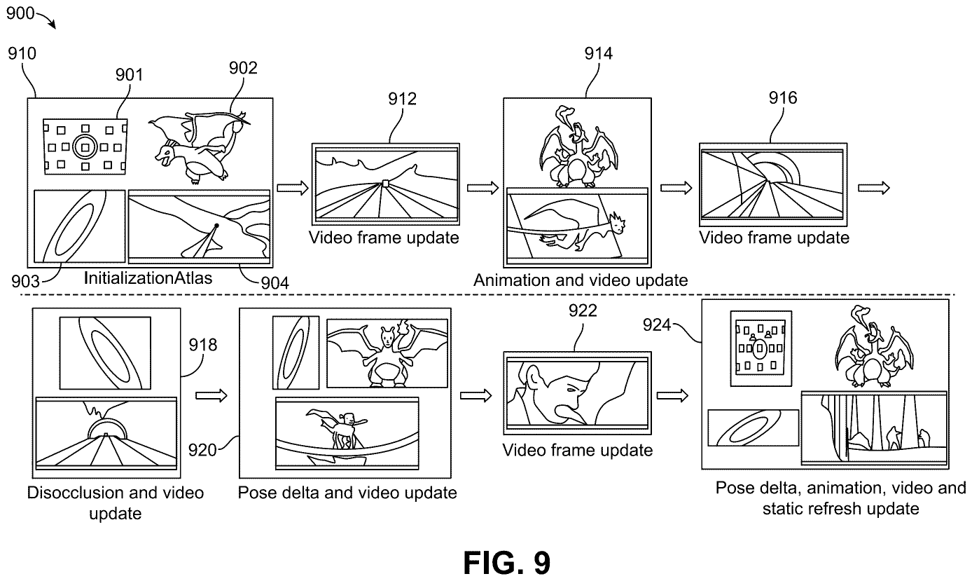

FIGS. 9-12 represent examples of variable transmission with an extended reality system. In particular, FIGS. 9-12 represent identical updates to objects, but with different approaches to encoding the updates.

FIG. 9 illustrates an example 900 of variable transmission within an extended reality system, in accordance with aspects of the present disclosure. Example 900 includes a sequence of video frames 910, 912, 914, 916, 918, 920, 922, and 924.

Example 900 represents a configuration in which the video encoder is configured in intra mode. In intra mode, the video coder only uses intra-frame prediction, generating only “I-frames.” In this mode, adjacent frames are not used for prediction, therefore the coder has no frame-to-frame state. The frames therefore may be decoded independently from each other. While this encoder configuration typically provides higher quality relative to encoding using predicted frames (“P-frames”), which may be temporally or spatially predicted, this configuration results in a higher bit rate, which may result in higher power consumption.

In the example depicted, given that the video encoder is intra mode, the host system does not place each object in an encoded video frame, as this would cause an increase in bit rate as an object would need to be encoded for each frame. Rather, the host system only provides objects to the video encoder that have changed relative to the last frame.

In the example depicted, frame 910 includes four objects 901, 902, 903, and 904. Because frame 910 includes all objects in a scene, frame 910 may be referred to as an initial atlas of objects. By contrast, frame 912 only includes object 904, as object 904 has changed relative to frame 910. Accordingly, no additional objects are provided to the video encoder for encoding, resulting in a compression savings. For example, had additional objects been provided to the encoder, because of the encoder being in I-frame mode, the additional objects would have been unnecessarily encoded as the encoder would not have leveraged the data from frame 910.

Continuing the example, frame 914 includes two different objects as compared to frame 912, specifically object 902 and object 904. As can be seen, object 902 has animated (e.g., changed position) relative to its position in frame 910. Accordingly, an updated object 902 is provided for encoding. Additionally, object 904, which is a video scene, has updated, and therefore, is also provided.

Frame 916 includes only object 904, as object 904 has updated again relative to frame 914. Frame 918 includes object 903, which has updated relative to frame 910, and object 904, which has again updated relative to frame 916. Frame 920 includes three objects, object 903, which has updated relative to frame 918, object 902, which has updated relative to frame 914, and object 904, which has again updated relative to frame 918. Frame 922 includes only object 904, which has updated relative to frame 920. Finally, frame 922, includes all objects 901-904, each of which have updated relative to their respective last transmissions.

As can be seen from frames 910-924, the transmitted atlas continuously changes size on each frame transmission. This change can impact encoding efficiency and power, because temporal incoherence of object location in an atlas for consecutive transmissions results in a high bitrate, which can result in higher power consumption than the power saved due to the smaller size of the encoded frame. Also, in this example, a render and transmission rate are bottlenecked by the rate of refresh for the highest refresh layer. here you are bound by highest refresh rate of all objects regardless of whether needed or not.

Given that signaling may be needed for the headset device to wake up a wireless modem to receive transmission at appropriate time, frequent adjustments to the frequency can potentially consume more power than any power savings gained with variable transmission. In some cases, a signaling mechanism can be included in transmission packets to vary transmission rate in bursts, for example, for 2-3 seconds, when high motion is predicted, can switch to higher rate, then back down to lower rate for the next interval.

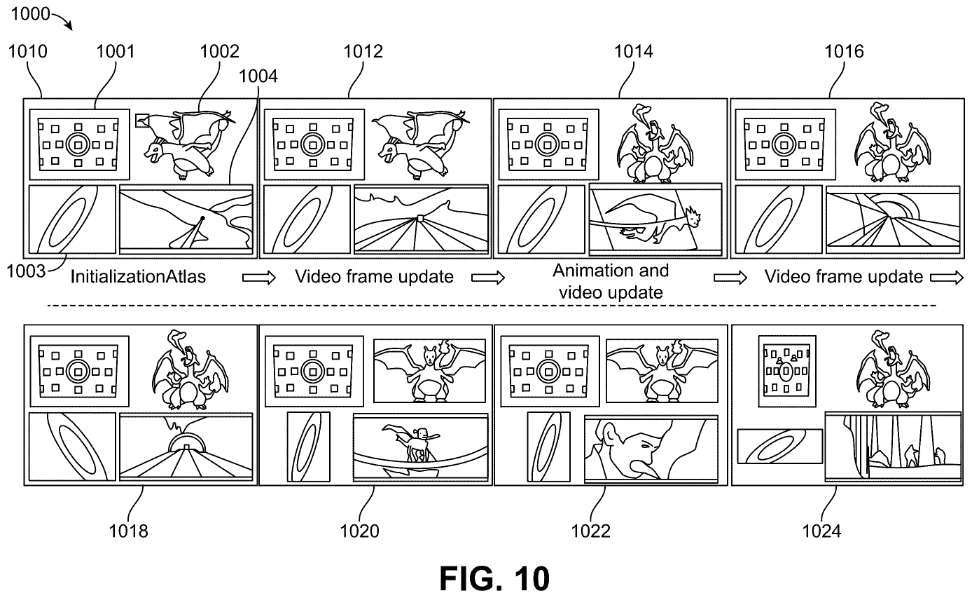

FIG. 10 illustrates an example 1000 of variable transmission within an extended reality system, in accordance with aspects of the present disclosure. Example 1000 includes video frames 1010, 1012, 1014, 1016, 1018, 1020, 1022, and 1024.

Example 1000 represents a configuration in which the video encoder is configured to maintain a state, e.g., by using both intra- and inter-frame prediction. In this configuration, the system may provide objects to the video encoder, even if the objects have not changed, because the video coder will be able to encode most or all of the additional object with minimal additional data due to inter-frame prediction.

Frame 1010 depicts objects 1001, 1002, 1003, and 1004. Frame 1010 may represent an initial atlas of objects. As can be seen, each frame 1012-1024 includes copies of objects 1001-1004. But relative to the previous frame, each object 1001-1004 in the frame may not be updated, and are updated only as appropriate. Object 1001 is not updated between frames 1012 to 1022. Object 1001 is initialized in frame 1010 and then the next update occurs in the last frame (frame 1024). By contrast, object 1004 is updated in each frame 1010-1024.

As the video encoder will exploit the temporal redundancy, this approach does not result in a material increase in encoding size. However, this approach can result in little or no space for additional objects, as space within the frame is occupied by objects which do not need to be transmitted. Accordingly, in these cases, performance may suffer as objects may be delayed until there is space in a future frame. Advantages of this approach include an atlas having a consistent size. This can create temporal consistency, resulting in a lower bit rate, which may save more power.

Signaling needed for viewer to wake up its modem to receive transmission at appropriate time, changing this continuously will burn more power than what is saved with variable transmission. A signaling mechanism may be included in transmission packets to vary transmission rate in bursts, for example, for 2-3 seconds. Then, when high motion is predicted, the system can switch to a higher rate for a time period.

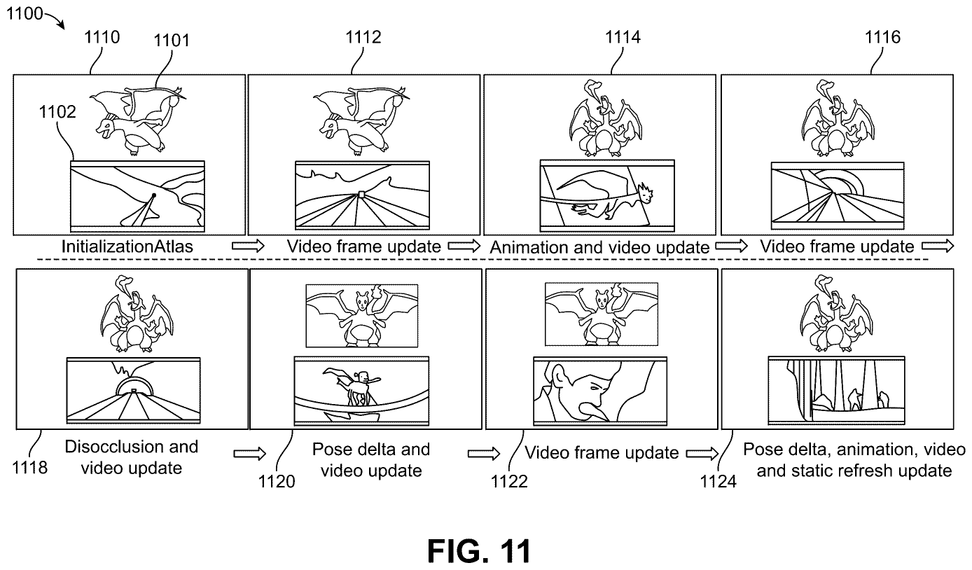

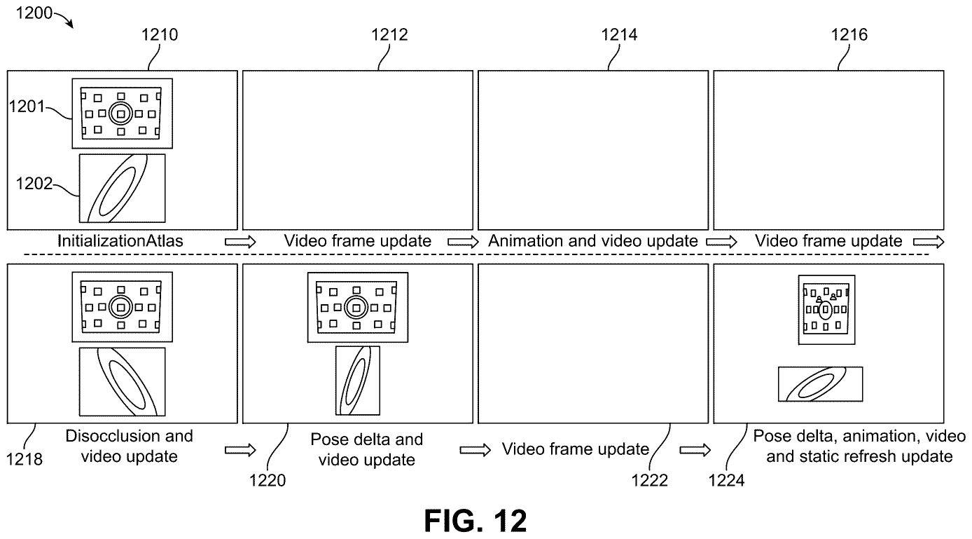

The examples depicted in FIGS. 9 and 10 reveal limitations that are addressed by aspects described with respect to FIGS. 11 and 12, which employ two or more video streams at different bit rates. This approach provides objects which need to be updated more frequently into a higher bit rate stream, and objects which do not need frequent updates into a lower bit rate stream.

FIG. 11 illustrates an example 1000 of variable transmission within an extended reality system, in accordance with aspects of the present disclosure. Example 1100 includes video frames 1110, 1112, 1114, 1116, 1118, 1120, 1122, and 1124.

Example 1100 represents a high bit rate stream of a configuration in which the system creates two or more streams of differing bit rates. Frame 1110 includes objects 1101 and 1102. Objects 1101 and 1102 are provided to the video encoder regardless of whether a particular object has changed relative to the previous frame. Because the video encoder is set to use intra-prediction and maintain a state, any redundancy in objects between frames is exploited and results in minimal additional data.

FIG. 12 illustrates an example 1200 of variable transmission within an extended reality system, in accordance with aspects of the present disclosure. Example 1200 includes video frames 1210, 1212, 1214, 1216, 1218, 1220, 1222, and 1224.

Example 1200 represents a low bit rate stream of a configuration in which the system creates two or more streams of differing bit rates. In some cases, a stream such as example 1200 may be transmitted in parallel with a stream such as example 1100. In the example depicted in example 1200, only updated objects are provided to the video encoder. In this manner, the video coder maintains a lower output bitrate. In some cases, the video coder used for the low bit rate stream may be configured in intra mode.

Frame 1210 includes objects 1201 and 1202. By contrast, frames 1212, 1214, and 1216 do not include any objects. Frame 1218 includes updated copies of objects 1201 and 1202 relative to frame 1210. Object 1201 is provided even though it has not changed.

Frame 1220 includes updated copies of objects 1201 and 1202 relative to frame 1218. Frame 1222 includes no objects. Finally, frame 1224 includes updated copies of objects 1201 and 1202. As can be seen, object 1201 is viewed from a significantly different perspective, which required an update, and object 1202 has also changed.

In the representation of FIG. 12, empty frames 1212, 1214, 1216, 1222 can be frames that are essentially skipped (e.g., no transmission). A signaling mechanism can be used to implement the variable transmission needed to transmit and receive only the non-empty frames, resulting in optimal power and transmission while maintaining visual quality.

If a high bit rate stream and a low bit rate stream are utilized, there will be two object atlases: one grouped with content that requires a higher rate of render and transmission, and one that requires a lower rate of render and transmission. Each atlas has consistent size, impacting encoding efficiency and power, temporal coherence results in lower bitrate, which is a bigger power saver than the size of the encoded frame. The render and transmission rate may now be atlas-dependent, as for each atlas the rate is limited by the highest render rate content. In some cases, with two or more atlases, a lower rate of rendering and transmission may be possible.

Given that signaling may be needed for the headset device to wake up a wireless modem to receive transmission at appropriate time, frequent adjustments to the frequency can potentially consume more power than any power savings gained with variable transmission. In some cases, a signaling mechanism can be included in transmission packets to vary transmission rate in bursts, for example, for 2-3 seconds, when high motion is predicted, can switch to higher rate, then back down to lower rate for the next interval.

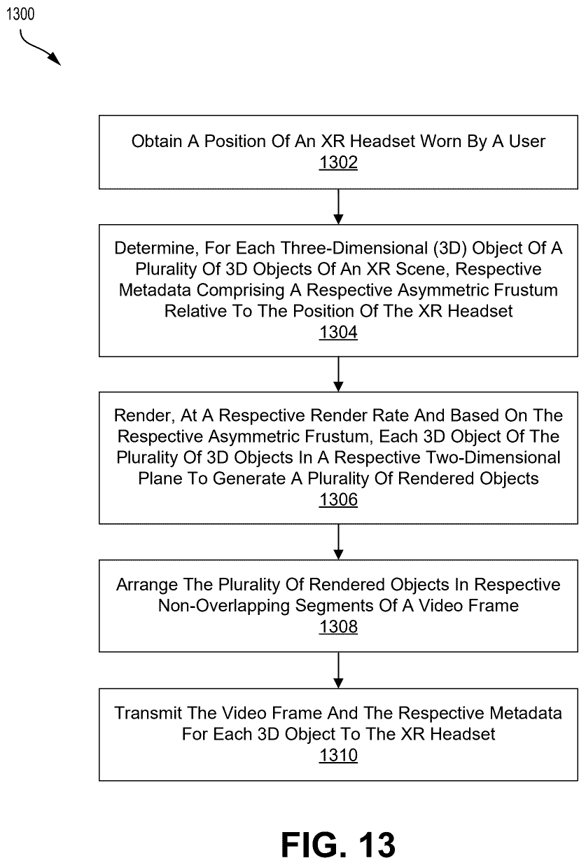

FIG. 13 is a flow diagram illustrating a process for rendering a frame, in accordance with aspects of the present disclosure. Process 1300 may be performed by a computing device (or apparatus) or a component (e.g., a chipset, codec, etc.) of the computing device (e.g., image capture and processing system 100, of FIG. 1, XR system 200 of FIG. 2, HMD 440 of FIG. 4, computing system 1500 of FIG. 15, etc.). The computing device may be a mobile device (e.g., a mobile phone), a network-connected wearable such as a watch, a vehicle or component or system of a vehicle, or other type of computing device. The operations of the process 1300 may be implemented as software components that are executed and run on one or more processors (e.g., image processor 150, host processor 152 of FIG. 1, compute components 210 of FIG. 2, processor 1510 of FIG. 15, etc.).

At block 1302, the computing device (or component thereof) can obtain a position of an XR headset worn by a user.

At block 1304, the computing device (or component thereof) can determine, for each three-dimensional (3D) object of a plurality of 3D objects of an XR scene, respective metadata including a respective asymmetric frustum relative to the position of the XR headset. In some cases, the metadata includes a respective eye buffer and plane equation. In some aspects, to determine the metadata, the computing device (or component thereof) can determine a future position of the user. In some cases, the computing device (or component thereof) can render each 3D object based on the future position.

At block 1306, the computing device (or component thereof) can render, at a respective render rate and based on the respective asymmetric frustum, each 3D object of the plurality of 3D objects in a respective two-dimensional plane to generate a plurality of rendered objects.

At block 1308, the computing device (or component thereof) can arrange the plurality of rendered objects in respective non-overlapping segments of a video frame (e.g., as shown in FIG. 5A-FIG. 6 and/or FIGS. 9-FIG. 12). In some aspects, at least two of the plurality of 3D objects are rendered at different render rates. In some cases, each of the different render rates is different from a frame rate of the video frame. In some examples, the video frame includes multiple segments.

At block 1310, the computing device (or component thereof) can transmit the video frame and the respective metadata for each 3D object to the XR headset. In some aspects, the computing device (or component thereof) can include the metadata in an XR object atlas. In such aspects, the computing device (or component thereof) can transmit the metadata to the XR headset within the XR object atlas (e.g., as discussed with respect to FIG. 5A-FIG. 12). In some cases, the video frame can also be included the XR object atlas.

In some aspects, to transmit the video frame to the XR headset, the computing device (or component thereof) can encode, at a frame rate determined by a wireless link to the XR headset, the video frame into an encoded video stream and transmit the encoded video stream to the XR headset over the wireless link. In some cases, the computing device (or component thereof) can determine the frame rate based on a minimum of a wireless transmission rate and a display refresh rate of the XR headset. In some aspects, the computing device (or component thereof) can transmit the video frame and the respective metadata for each 3D object to the XR headset at a first transmission rate and can transmit an additional video frame at a second transmission rate that is different from the first transmission rate.

In some cases, the computing device (or component thereof) can transmit the video frame at a first frame rate. The computing device (or component thereof) can identify an additional 3D object and can determine, for the additional 3D object, additional metadata including an additional asymmetric frustum relative to the position. The computing device (or component thereof) can render the additional 3D object in a respective two-dimensional plane and can arrange the rendered additional 3D object in an additional video frame. The computing device (or component thereof) can transmit, to the XR headset and at a second frame rate, the additional video frame and the additional metadata.

In some aspects, the computing device (or component thereof) can determine that a 3D object of the plurality of 3D objects has changed. The computing device (or component thereof) can determine, for the changed 3D object, updated metadata including an updated asymmetric frustum relative to the position. The computing device (or component thereof) can render the changed object in an updated two-dimensional plane based on the updated asymmetric frustum and can arrange the rendered changed 3D object in an updated video frame. The computing device (or component thereof) can transmit, to the XR headset, the updated video frame and the updated metadata.

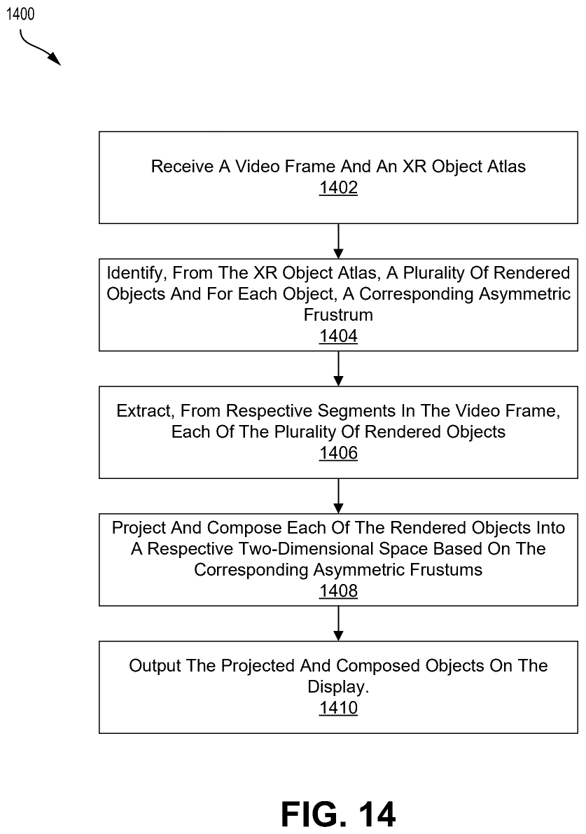

FIG. 14 is a flow diagram illustrating a process for rendering a frame, in accordance with aspects of the present disclosure. Process 1400 may be performed by a computing device (or apparatus) or a component (e.g., a chipset, codec, etc.) of the computing device (e.g., image capture and processing system 100, of FIG. 1, XR system 200 of FIG. 2, HMD 440 of FIG. 4, computing system 1500 of FIG. 15, etc.). The computing device may be an XR device, such as a VR device or AR device, or other type of computing device. The operations of the process 1400 may be implemented as software components that are executed and run on one or more processors (e.g., image processor 150, host processor 152 of FIG. 1, compute components 210 of FIG. 2, processor 1510 of FIG. 15, etc.).

At block 1402, the computing device (or component thereof) can receive a video frame and an XR object atlas.

At block 1404, the computing device (or component thereof) can identify, from the XR object atlas, a plurality of rendered objects and for each object, a corresponding asymmetric frustum.

At block 1406, the computing device (or component thereof) can extract, from respective segments in the video frame, each of the plurality of rendered objects.

At block 1408, the computing device (or component thereof) can project and compose each of the rendered objects into a respective two-dimensional space based on the corresponding asymmetric frustums.

At block 1410, the computing device (or component thereof) can output the projected and composed objects on the display.

In some aspects, the computing device (or component thereof) can determine an updated position of the apparatus and can transmit the updated position to a host device. In some cases, the host device is or includes the apparatus. In some cases, the computing device (or component thereof) can receive an updated video frame and updated metadata. The computing device can update the XR object atlas with the updated metadata.

In some aspects, the computing device (or component thereof) can receive an updated video frame and a corresponding updated XR object atlas. The computing device (or component thereof) can determine, from the updated XR object atlas, an updated object of the plurality of rendered objects and a corresponding asymmetric frustum. In some cases, the computing device (or component thereof) can extract, from the updated video frame, the updated object. The computing device (or component thereof) can project (or display) and compose the updated object into a respective 2D space based on the corresponding asymmetric frustum. The computing device (or component thereof) can update the display with the updated object.

As noted herein, the techniques or processes described herein (e.g., the process 1300) may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the processes 1300 and 1400 and/or other processes described herein may include a processor, microprocessor, micro-computer, or other component of a device that is configured to carry out the steps of the processes 1300 and 1400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1300 and 1400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1300 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some examples, computing system 1500 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1500 includes at least one processing unit (CPU or processor) 1510 and connection 1505 that couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, camera, accelerometers, gyroscopes, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some examples, a hardware service that performs a particular function can include the software component stored in a computer-readable medium in connection with the necessary hardware components, such as processor 1510, connection 1505, output device 1535, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:
Aspect 1. An apparatus for extended reality (XR), the apparatus comprising: at least one memory; and at least one processor coupled to the at least one memory and configured to: obtain a position of an XR headset worn by a user; determine, for each three-dimensional (3D) object of a plurality of 3D objects of an XR scene, respective metadata comprising a respective asymmetric frustum relative to the position of the XR headset; render, at a respective render rate and based on the respective asymmetric frustum, each 3D object of the plurality of 3D objects in a respective two-dimensional plane to generate a plurality of rendered objects; arrange the plurality of rendered objects in respective non-overlapping segments of a video frame; and transmit the video frame and the respective metadata for each 3D object to the XR headset.
Aspect 2. The apparatus of Aspect 1, wherein, to transmit the video frame to the XR headset, the at least one processor is configured to: encode, at a frame rate determined by a wireless link to the XR headset, the video frame into an encoded video stream; and transmit the encoded video stream to the XR headset over the wireless link.
Aspect 3. The apparatus of any of Aspects 1 or 2, wherein the respective metadata for each 3D object is included in an XR object atlas, and wherein the at least one processor is configured to transmit the respective metadata for each 3D object to the XR headset within the XR object atlas.
Aspect 4. The apparatus of any of Aspects 2 or 3, wherein the at least one processor is configured to determine the frame rate based on a minimum of a wireless transmission rate and a display refresh rate of the XR headset.
Aspect 5. The apparatus of any of Aspects 1-4, wherein at least two of the plurality of 3D objects are rendered at different render rates, and wherein each of the different render rates is different from a frame rate of the video frame.
Aspect 6. The apparatus of any of Aspects 1-5, wherein the at least one processor is configured to: determine that a 3D object of the plurality of 3D objects has changed; determine, for the changed 3D object, updated metadata comprising an updated asymmetric frustum relative to the position; render the changed 3D object in an updated two-dimensional plane based on the updated asymmetric frustum to form a rendered changed 3D object; arrange the rendered changed 3D object in an updated video frame; and transmit, to the XR headset, the updated video frame and the updated metadata.
Aspect 7. The apparatus of any of Aspects 1-6, wherein the at least one processor is configured to: transmit the video frame at a first frame rate; identify an additional 3D object; determine, for the additional 3D object, additional metadata comprising an additional asymmetric frustum relative to the position; render the additional 3D object in a respective two-dimensional plane to form a rendered additional 3D object; arrange the rendered additional 3D object in an additional video frame; and transmit, to the XR headset and at a second frame rate, the additional video frame and the additional metadata.
Aspect 8. The apparatus of any of Aspects 1-7, wherein the at least one processor is configured to: transmit the video frame and the respective metadata for each 3D object to the XR headset at a first transmission rate; and transmit an additional video frame at a second transmission rate that is different from the first transmission rate.
Aspect 9. The apparatus of any of Aspects 1-8, wherein the video frame comprises multiple segments.
Aspect 10. The apparatus of any of Aspects 1-9, wherein the respective metadata for each 3D object comprises a respective eye buffer and plane equation.
Aspect 11. The apparatus of any of Aspects 1-10, wherein, to determine the respective metadata, the at least one processor is configured to determine a future position of the user, and wherein the at least one processor is configured to render each 3D object based on the future position.
Aspect 12. An apparatus for extended reality (XR), comprising: at least one memory; and at least one processor coupled to the at least one memory and configured to: receive a video frame and an XR object atlas comprising metadata; determine, from the XR object atlas, a plurality of rendered objects and a respective asymmetric frustum for each rendered object of the plurality of rendered objects; extract, from respective segments in the video frame, each of the plurality of rendered objects; project and compose each rendered object of the plurality of rendered objects into a respective two-dimensional (2D) space based on the respective asymmetric frustums; and output the projected and composed rendered objects to a display.
Aspect 13. The apparatus of Aspect 12, wherein the at least one processor is further configured to: determine an updated position of the apparatus; and transmit the updated position to a host device.
Aspect 14. The apparatus of any of Aspects 12-13, wherein the at least one processor is further configured to: receive an updated video frame and updated metadata; and update the XR object atlas with the updated metadata.
Aspect 15. The apparatus of any of Aspects 12-14, wherein the at least one processor is further configured to: receive an updated video frame and a corresponding updated XR object atlas; determine, from the updated XR object atlas, an updated object of the plurality of rendered objects and a corresponding asymmetric frustum; extract, from the updated video frame, the updated object; project and compose the updated object into a respective 2D space based on the corresponding asymmetric frustum; and update the display with the updated object.
Aspect 16. The apparatus of any of Aspects 12-15, further comprising the display.
Aspect 17. A method comprising: obtaining a position of an XR headset worn by a user; determining, for each three-dimensional (3D) object of a plurality of 3D objects of an XR scene, respective metadata comprising a respective asymmetric frustum relative to the position of the XR headset; rendering, at a respective render rate and based on the respective asymmetric frustum, each 3D object of the plurality of 3D objects in a respective two-dimensional plane to generate a plurality of rendered objects; arranging the plurality of rendered objects in respective non-overlapping segments of a video frame; and transmitting the video frame and the respective metadata for each 3D object to the XR headset.
Aspect 18. The method of Aspect 17, further comprising: encoding, at a frame rate determined by a wireless link to the XR headset, the video frame into an encoded video stream; and transmitting the encoded video stream to the XR headset over the wireless link.
Aspect 19. The method of Aspect 18, wherein the respective metadata for each 3D object is included in an XR object atlas, and further comprising transmitting the respective metadata for each 3D object to the XR headset within the XR object atlas.
Aspect 20. The method of any of Aspects 18 or 19, further comprising determining the frame rate based on a minimum of a wireless transmission rate and a display refresh rate of the XR headset.
Aspect 21. The method of any of Aspects 17 to 20, wherein at least two of the plurality of 3D objects are rendered at different render rates, and wherein each of the different render rates is different from a frame rate of the video frame.
Aspect 22. The method of any of Aspects 17 to 21, further comprising: determining that a 3D object of the plurality of 3D objects has changed; determine, for the changed 3D object, updated metadata comprising an updated asymmetric frustum relative to the position; rendering the changed object in an updated two-dimensional plane based on the updated asymmetric frustum; arrange the rendered changed 3D object in an updated video frame; and transmitting, to the XR headset, the updated video frame and the updated metadata.
Aspect 23. The method of any of Aspects 17 to 22, further comprising: transmitting the video frame at a first frame rate; identifying an additional 3D object; determining, for the additional 3D object, additional metadata comprising an additional asymmetric frustum relative to the position; rendering the additional 3D object in a respective two-dimensional plane; arranging the rendered additional 3D object in an additional video frame; and transmitting, to the XR headset and at a second frame rate, the additional video frame and the additional metadata.
Aspect 24. The method of any of Aspects 17 to 23, further comprising: transmitting the video frame and the respective metadata for each 3D object to the XR headset at a first transmission rate; and transmitting an additional video frame at a second transmission rate that is different from the first transmission rate.
Aspect 24. The method of any of Aspects 17 to 24, wherein the video frame comprises multiple segments.
Aspect 25. The method of any of Aspects 17 to 24, wherein the respective metadata for each 3D object comprises a respective eye buffer and plane equation.
Aspect 26. The method of any of Aspects 17 to 25, wherein determining the respective metadata comprises determining a future position of the user, and further comprising rendering each 3D object based on the future position.
Aspect 27. A method comprising: receiving a video frame and an XR object atlas comprising metadata; determining, from the XR object atlas, a plurality of rendered objects and a respective asymmetric frustum for each rendered object of the plurality of rendered objects; extracting, from respective segments in the video frame, each of the plurality of rendered objects; projecting and composing each rendered object of the plurality of rendered objects into a respective two-dimensional (2D) space based on the respective asymmetric frustums; and outputting the projected and composed objects to a display.
Aspect 28. The method of Aspect 27, further comprising: determining an updated position; and transmitting the updated position to a host device.
Aspect 29. The method of any of Aspects 27 or 28, further comprising receiving an updated video frame and updated metadata; and updating the XR object atlas with the updated metadata.
Aspect 30. The method of any of Aspects 27 to 29, further comprising receiving an updated video frame and a corresponding updated XR object atlas; determining, from the updated XR object atlas, an updated object of the plurality of rendered objects and a corresponding asymmetric frustum; extracting, from the updated video frame, the updated object; projecting and composing the updated object into a respective 2D space based on the corresponding asymmetric frustum; and updating the display with the updated object.
Aspect 31. The method of any of Aspects 27 to 30, further comprising the display.
Aspect 32. A non-transitory computer-readable medium having stored thereon instructions that, when executed by at least one processor, cause the at least one processor to perform operations according to any of Aspects 17 to 26.
Aspect 33. An apparatus for extended reality (XR), the apparatus including one or more means for performing operations according to any of Aspects 17 to 26.
Aspect 32. A non-transitory computer-readable medium having stored thereon instructions that, when executed by at least one processor, cause the at least one processor to perform operations according to any of Aspects 27 to 31.
Aspect 33. An apparatus for extended reality (XR), the apparatus including one or more means for performing operations according to any of Aspects 27 to 31.

What is claimed is:

1. An apparatus for extended reality (XR), the apparatus comprising:
at least one memory; and
at least one processor coupled to the at least one memory and configured to:
obtain a position of an XR headset worn by a user;
determine, for each three-dimensional (3D) object of a plurality of 3D objects of an XR scene, respective metadata comprising a respective asymmetric frustum relative to the position of the XR headset;
render, at a respective render rate and based on the respective asymmetric frustum, each 3D object of the plurality of 3D objects in a respective two-dimensional plane to generate a plurality of rendered objects;
arrange the plurality of rendered objects in respective non-overlapping segments of a video frame; and
transmit the video frame and the respective metadata for each 3D object to the XR headset.

2. The apparatus of claim 1, wherein, to transmit the video frame to the XR headset, the at least one processor is configured to:
encode, at a frame rate determined by a wireless link to the XR headset, the video frame into an encoded video stream; and
transmit the encoded video stream to the XR headset over the wireless link.

3. The apparatus of claim 2, wherein the respective metadata for each 3D object is included in an XR object atlas, and wherein the at least one processor is configured to transmit the respective metadata for each 3D object to the XR headset within the XR object atlas.

4. The apparatus of claim 2, wherein the at least one processor is configured to determine the frame rate based on a minimum of a wireless transmission rate and a display refresh rate of the XR headset.

5. The apparatus of claim 1, wherein at least two of the plurality of 3D objects are rendered at different render rates, and wherein each of the different render rates is different from a frame rate of the video frame.

6. The apparatus of claim 1, wherein the at least one processor is configured to:
determine that a 3D object of the plurality of 3D objects has changed;
determine, for the changed 3D object, updated metadata comprising an updated asymmetric frustum relative to the position;
render the changed 3D object in an updated two-dimensional plane based on the updated asymmetric frustum to form a rendered changed 3D object;
arrange the rendered changed 3D object in an updated video frame; and
transmit, to the XR headset, the updated video frame and the updated metadata.

7. The apparatus of claim 1, wherein the at least one processor is configured to:
transmit the video frame at a first frame rate;
identify an additional 3D object;
determine, for the additional 3D object, additional metadata comprising an additional asymmetric frustum relative to the position;
render the additional 3D object in a respective two-dimensional plane to form a rendered additional 3D object;
arrange the rendered additional 3D object in an additional video frame; and
transmit, to the XR headset and at a second frame rate, the additional video frame and the additional metadata.

8. The apparatus of claim 1, wherein the at least one processor is configured to:
transmit the video frame and the respective metadata for each 3D object to the XR headset at a first transmission rate; and
transmit an additional video frame at a second transmission rate that is different from the first transmission rate.

9. The apparatus of claim 1, wherein the video frame comprises multiple segments.

10. The apparatus of claim 1, wherein the respective metadata for each 3D object comprises a respective eye buffer and plane equation.

11. The apparatus of claim 1, wherein, to determine the respective metadata, the at least one processor is configured to determine a future position of the user, and wherein the at least one processor is configured to render each 3D object based on the future position.

12. An apparatus for extended reality (XR), comprising:
at least one memory; and
at least one processor coupled to the at least one memory and configured to:
receive a video frame and an XR object atlas comprising metadata;
determine, from the XR object atlas, a plurality of rendered objects and a respective asymmetric frustum for each rendered object of the plurality of rendered objects;
extract, from respective segments in the video frame, each of the plurality of rendered objects;
project and compose each rendered object of the plurality of rendered objects into a respective two-dimensional (2D) space based on the respective asymmetric frustums; and
output the projected and composed rendered objects to a display.

13. The apparatus of claim 12, wherein the at least one processor is further configured to:
determine an updated position of the apparatus; and
transmit the updated position to a host device.

14. The apparatus of claim 12, wherein the at least one processor is further configured to:
receive an updated video frame and updated metadata; and
update the XR object atlas with the updated metadata.

15. The apparatus of claim 12, wherein the at least one processor is further configured to:
receive an updated video frame and a corresponding updated XR object atlas;
determine, from the updated XR object atlas, an updated object of the plurality of rendered objects and a corresponding asymmetric frustum;
extract, from the updated video frame, the updated object;
project and compose the updated object into a respective 2D space based on the corresponding asymmetric frustum; and
update the display with the updated object.

16. The apparatus of claim 12, further comprising the display.

17. A method comprising:
obtaining a position of an XR headset worn by a user;
determining, for each three-dimensional (3D) object of a plurality of 3D objects of an XR scene, respective metadata comprising a respective asymmetric frustum relative to the position of the XR headset;
rendering, at a respective render rate and based on the respective asymmetric frustum, each 3D object of the plurality of 3D objects in a respective two-dimensional plane to generate a plurality of rendered objects;
arranging the plurality of rendered objects in respective non-overlapping segments of a video frame; and
transmitting the video frame and the respective metadata for each 3D object to the XR headset.

18. The method of claim 17, further comprising:
encoding, at a frame rate determined by a wireless link to the XR headset, the video frame into an encoded video stream; and
transmitting the encoded video stream to the XR headset over the wireless link.

19. A method comprising:
receiving a video frame and an XR object atlas comprising metadata;
determining, from the XR object atlas, a plurality of rendered objects and a respective asymmetric frustum for each rendered object of the plurality of rendered objects;
extracting, from respective segments in the video frame, each of the plurality of rendered objects;
projecting and composing each rendered object of the plurality of rendered objects into a respective two-dimensional (2D) space based on the respective asymmetric frustums; and
outputting the projected and composed objects to a display.

20. The method of claim 19, further comprising:
determining an updated position; and
transmitting the updated position to a host device.
